(19) United States
(12) Patent Application Publication
(10) Pub. No.: US 2006/0215288 A1
(43) Pub. Date: Sep. 28, 2006

(54) Image forming apparatus with power-saving mode

(76) Inventor: Hiroaki Takeuchi, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/377,560

(22) Filed: Mar. 17, 2006

(30) Foreign Application Priority Data
Mar. 17, 2005 (JP) 2005-077808

(51) Int. Cl. G11B 25/04

(52) U.S. Cl. 360/2

(57) ABSTRACT

An image forming apparatus has a power-saving mode during which a power is supplied to a power supply controller and no power is supplied to other components. A detection signal for detecting an insertion and a removal of a storage medium is connected to the power supply controller and an interface unit for the storage medium. When the storage medium is inserted into the interface unit during the power-saving mode, the power supply controller switches, based on the detection signal, the power-saving mode to a normal operating mode during which the image forming apparatus is turned on.

### CROSS-REFERENCE TO RELATED APPLICATIONS

The present document incorporates by reference the entire contents of Japanese priority document, 2005-077808 filed in Japan on Mar. 17, 2005.

### BACKGROUND OF THE INVENTION

1. Field of the Invention

The present invention relates to an image forming apparatus with a removable storage medium, and more particularly, to a technology for controlling a power-saving mode and a state of use of a storage medium according to insertion and removal of the storage medium.

2. Description of the Related Art

Generally, when an image forming apparatus is unused for a certain period of time, its status gradually shifts to a power-saving mode. In the most advanced power-saving modes, power supplies for central processing units (CPU) are usually turned off.

Recently, hot-swappable storage media including secure digital (SD) cards and compact flash (CF) cards are widely used. Image data stored in such storage media is printed, and software is upgraded, using the storage media (see, for example, Japanese Patent Application Laid-Open No. 2004-46802).

Most of the storage media need to be initialized before being used. For example, according to a conventional technique disclosed in Japanese Patent Application Laid-Open No. 2003-335028, information about the insertion and removable of the storage medium is notified to a program running unit. The program running unit boots up a storage medium starting unit to initialize the storage medium.

However, Japanese Patent Application Laid-Open No. 2003-335028 merely describes about a conventional technique in which the information about the insertion and removal of the storage medium and about the initialization of the storage medium are notified to a program for running a user service program when the image forming apparatus is turned on. Japanese Patent Application Laid-Open No. 2003-335028 does not particularly describe the relationship between the insertion and removal of the storage medium and the power-saving mode of the image forming apparatus.

### SUMMARY OF THE INVENTION

It is an object of the present invention to at least solve the problems in the conventional technology.

An image forming apparatus according to one aspect of the present invention includes an interface unit for a removable storage medium; a power supply controller that controls supplying a power to each component; and a CPU that controls overall operation of the image forming apparatus. The image forming apparatus has a power-saving mode during which the power is supplied to the power supply controller and no power is supplied to other components. A detection signal for detecting an insertion and a removal of the storage medium is connected to the power supply controller and the interface unit. When the storage medium is inserted into the interface unit during the power-saving mode, the power supply controller switches, based on the detection signal, the power-saving mode to an ordinary mode during which the image forming apparatus is turned on.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image forming apparatus according to an embodiment of the present invention, including a CPU, various memories, a removable storage medium, and a power supply system; and

FIG. 2 is a timing chart of a relationship between insertion and removal of the storage medium and various operational states including initialization of the storage medium in the image forming apparatus according to the present embodiment.

### DETAILED DESCRIPTION OF THE PREFERRED EMBODIMENTS

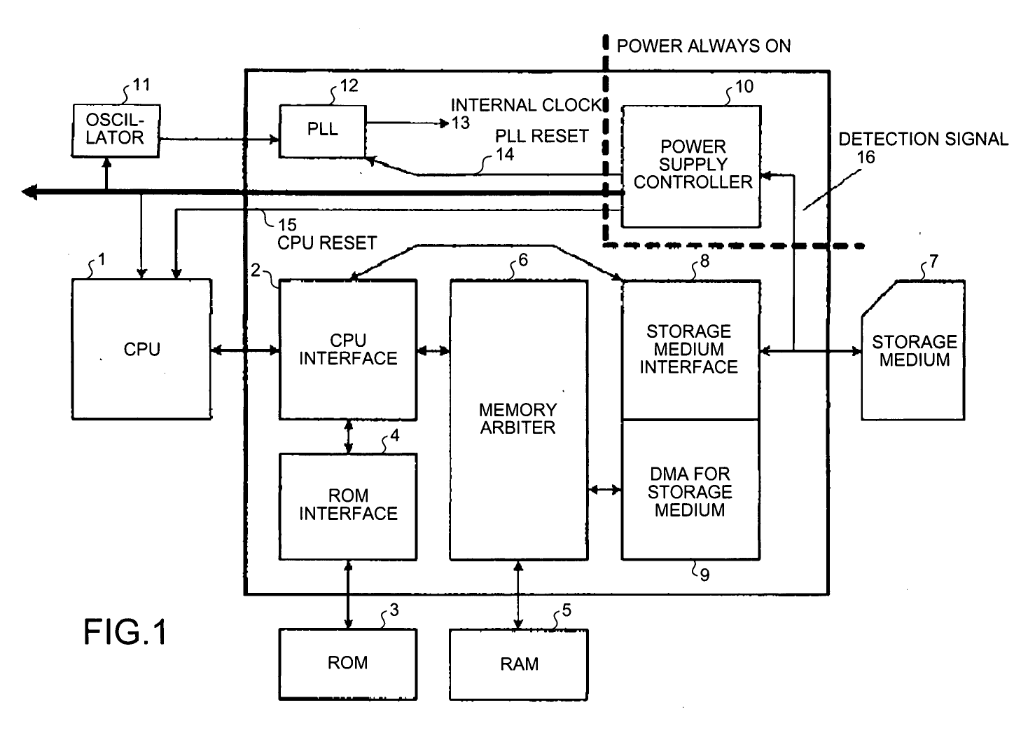

Exemplary embodiments of the present invention will be explained in detail below with reference to the accompanying drawings. FIG. 1 is a block diagram of an image forming apparatus according to an embodiment of the present invention.

As shown in FIG. 1, the image forming apparatus according to the present embodiment includes a CPU 1, a CPU interface unit 2, a read only memory (ROM) 3, a ROM interface unit 4, a random access memory (RAM) 5, a memory arbiter 6, a storage medium 7, a storage medium interface unit 8, a direct memory access (DMA) 9 for the storage medium 7, a power supply controller 10, an oscillator 11, a phase locked loop (PLL) 12, an internal clock 13, a PLL reset 14, a CPU reset 15, and a detection signal 16 for detecting insertion and removal of the storage-medium 7.

Schematically, the image forming apparatus includes at least the CPU interface unit 2 that interfaces to the CPU 1, the ROM interface unit 4 that interfaces access to the ROM 3 when the CPU 1 accesses the ROM space, the memory arbiter 6 for accessing the RAM 5, the storage medium interface unit 8 that interfaces to the storage medium 7, the DMA 9 for storage medium that performs DMA transfer using the storage medium 7, and the power supply controller 10 that controls the progress of a power-saving mode. The power supply controller 10 controls the power supply of a mechanical controller (not shown) and also controls powers supplied to various logic circuits.

According to the present embodiment, the power supply controller 10 is always turned on (this state is referred to as “power-saving mode”), and the various logic circuits, the CPU 1, the ROM 3, and the RAM 5 are on/off-controlled by the power supply controller 10. Therefore, only the power supply controller 10 consumes the power during the power-saving mode. Accordingly, only a small circuit that monitors changes of signals is turned on, resulting in a significant reduction in power consumption during the power-saving mode.

A key input signal from an operation unit (not shown) and a sensor input signal are connected to the power supply controller 10 as factors for returning to a normal operating mode. When any key is pressed or any input is provided from a sensor during the power-saving mode, the power supply is turned on to cancel the power-saving mode. According to the present embodiment, the detection signal 16 for detecting insertion and removal of the storage medium 7 is connected to the power supply controller 10. When the power supply controller 10 detects the insertion of the storage medium 7, the power supply controller 10 turns on the power supply which has been turned off during the power-saving mode (the apparatus is returned to the normal operating mode). When image data stored in the storage medium 7 is to be printed, the image forming apparatus can be booted simply by inserting the storage medium 7.

The storage medium interface unit 8 is a circuit for accessing the storage medium 7. The detection signal 16 for detecting the insertion and removal of the storage medium 7 is also connected to the storage medium interface unit 8. When the detection signal 16 detects the insertion of the storage medium 7, the storage medium interface unit 8 performs the initialization of the storage medium 7 on hardware. Since the storage medium 7 can be initialized regardless of programs, the time required by the apparatus to return from the power-saving mode is shortened.

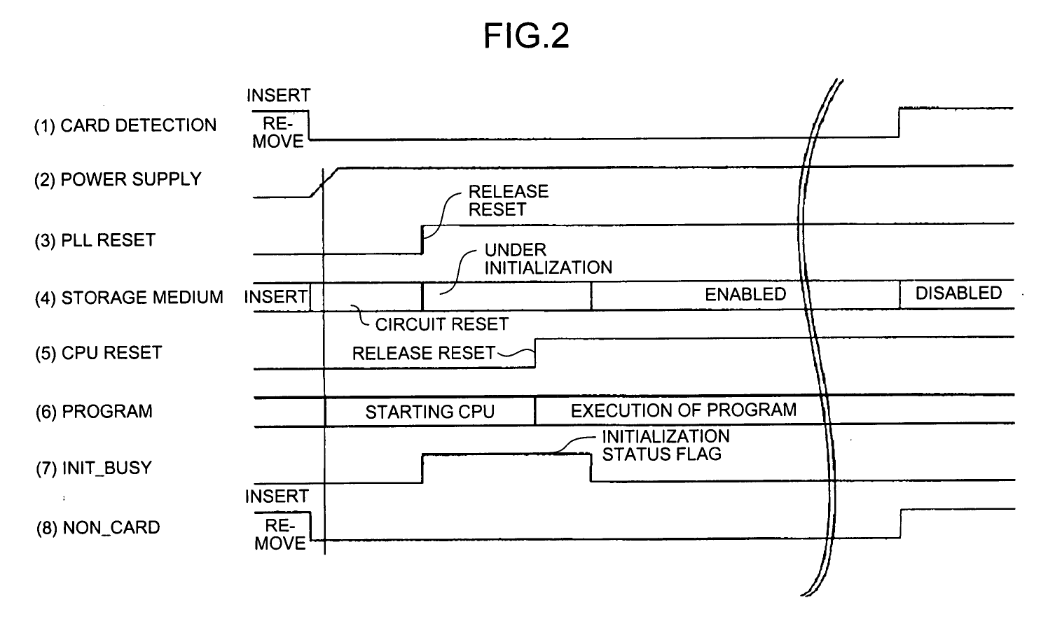

FIG. 2 is a timing chart of the operational states of the various components when the storage medium (for example, a card) is inserted and the various components are then turned on.

The power supply controller 10 turns on the various components in response to the detection signal 16 (see (1) in FIG. 2) which detects the insertion of a card (see (2) in FIG. 2). When the power supply is turned on, the oscillator 11 outputs clocks. Since some time is required for the PLL 12 used for supplying clocks used by the various logic circuits to oscillate clocks, the power supply controller 10 prepares the PLL reset 14 separately, and makes the PLL reset 14 operate until the clocks are stably output (see (3) in FIG. 2). During the operation of the PLL reset 14, the storage medium interface unit 8 is reset (see (4) in FIG. 2). When the reset is released, the storage medium interface unit 8 starts the initialization of the storage medium 7 (see (4) in FIG. 2).

The CPU 1 needs to be reset separately. The power supply controller 10 outputs the CPU reset 15 to the CPU 1. FIG. 2 is an example in which the CPU reset 15 is longer than the PLL reset 14 (see (5) in FIG. 2). When the reset is released, the CPU 1 fetches a program from the ROM 3 to execute it (see (6) in FIG. 2).

The initialization of the storage medium must be ended before the program uses the storage medium 7. A status flag INIT_BUSY which indicates that the initialization is being performed is provided in the storage medium interface unit 8 (see (7) in FIG. 2). The program determines whether the storage medium 7 can be used by monitoring the status flag. While INIT_BUSY is H, although the program is being executed (see (6) in FIG. 2), the storage medium 7 is being initialized (see (4) in FIG. 2). Therefore, the program checks the status flag so as not to access the storage medium 7 while INIT_BUSY is H (portion H). The software can determine whether the storage medium can be used.

The operation performed when the storage medium (card) is removed will be described next. As shown by (8) in FIG. 2, a portion where the detection signal 16 is changed from L to H indicates the removal of the card. When the card is only removed, the power supply does not need to be turned off. The power supplies for the various components, the PLL reset 14, and the CPU reset 15 are not changed. However, since the storage medium 7 is removed and cannot be used, a status flag NON_CARD which indicates that the card does not exist is provided (see (8) in FIG. 2). The program finds that the card has been removed by monitoring the status flag and does not access the card. Thus, the software can determine whether the storage medium exists.

As described above, according to the image forming apparatus of to the embodiment of the present invention, the signal for detecting the insertion and removal of the hot-swappable storage medium is connected to the power supply controller and the storage medium interface unit. The power supply is controlled by the insertion and removal of the storage medium and the storage medium is initialized on the hardware. Thus, even in the power-saving mode in which the CPU is turned off, when the storage medium is inserted, it is immediately initialized regardless of the software. As soon as the software starts, the storage medium can be used. As a result, the time required for starting the apparatus is shortened.

According to the present invention, when the image data stored in the removable storage medium is printed, the apparatus in the power-saving mode can be booted only by inserting the storage medium.

By detecting the insertion of the storage medium, the storage medium is initialized regardless of the program. Therefore, the time required for the apparatus to return from the power-saving mode is shortened. The status flag which indicates that the initialization is being performed is provided. Therefore, the program can determine whether the storage medium can be used by referring to the flag.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
an interface unit for a removable storage medium;
a power supply controller that controls supplying a power to each component; and
a central processing unit that controls overall operation of the image forming apparatus, wherein
the image forming apparatus has a power-saving mode during which the power is supplied to the power supply controller and no power is supplied to other components,
a detection signal for detecting an insertion and a removal of the storage medium is connected to the power supply controller and the interface unit, and
when the storage medium is inserted into the interface unit during the power-saving mode, the power supply controller switches, based on the detection signal, the power-saving mode to a normal operating mode during which the image forming apparatus is turned on.

2. The image forming apparatus according to claim 1, wherein
the power supply controller supplies the power to the interface unit based on the detection signal, and
the interface unit initializes the storage medium.

3. The image forming apparatus according to claim 2, wherein
the interface unit includes an initialization status flag that indicates that the initialization of the storage medium is being executed, and
a program of the central processing unit determines whether the storage medium is enabled by referring to the initialization status flag.

4. The image forming apparatus according to claim 1, wherein
the interface unit includes a nonexistence status flag that indicates that the storage medium does not exist based on the detection signal, and
a program of the central processing unit does not access the storage medium when the nonexistence status flag is set.
